(19) United States
(12) Patent Application Publication
(10) Pub. No.: US 2024/0095220 A1
(43) Pub. Date: Mar. 21, 2024

(54) ENSURING TRUST THROUGHOUT LIFECYCLE OF A NON-FUNGIBLE TOKEN

(71) Applicant: Salesforce, Inc., San Francisco, CA (US)

(72) Inventors: Charles Hart Isaacs, San Francisco, CA (US); Prithvi Krishnan Padmanabhan, San Francisco, CA (US); Mathew Sweezey, San Francisco, CA (US)

(73) Assignee: Salesforce, Inc., San Francisco, CA (US)

(21) Appl. No.: 17/933,827

(22) Filed: Sep. 20, 2022

(51) Int. Cl. G06F 16/21; G06F 16/22

(52) U.S. Cl. CPC G06F 16/211; G06F 16/2255

(57) ABSTRACT

Disclosed are some implementations of systems, apparatus, methods and computer program products for ensuring trust throughout the lifecycle of a non-fungible token. The system identifies, from a metadata data structure associated with the non-fungible token, a first network address associated with a first attribute of the metadata data structure. The system accesses a first file referenced by the first network address and generates a first hash value from contents of the first file. The system generates a modified metadata data structure that includes the first hash value by storing, within the metadata data structure, the first hash value in association with the first attribute. The system then generates a second hash value using the modified metadata data structure and stores, in a public trust ledger, a first smart contract including the second hash value and a second network address that references the modified metadata data structure. The system may then attempt to validate a smart contract based, at least in part, on the second hash value.

### COPYRIGHT NOTICE

A portion of the disclosure of this patent document contains material, which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever.

### TECHNICAL FIELD

This patent document relates generally to database systems and more specifically to interactions between database systems and public trust ledgers

### BACKGROUND

Cloud computing” services provide shared resources, applications, and information to computers and other devices upon request. In cloud computing environments, services can be provided by one or more servers accessible over the Internet rather than installing software locally on in-house computer systems. Users can interact with cloud computing services to undertake a wide range of tasks.

Another mechanism for storing information is a public trust ledger, such as a blockchain. A public trust ledger is a distributed repository in which transactions are recorded. Transactions can be monetary, such as recording a payment, or non-monetary, such as recording a transfer of ownership. A public trust ledger is a distributed repository that is publicly accessible and that is secured based on cryptographic protocols.

### BRIEF DESCRIPTION OF THE DRAWINGS

The included drawings are for illustrative purposes and serve only to provide examples of possible structures and operations for the disclosed systems, apparatus, methods and computer program products for validating smart contracts and ensuring continued integrity of non-fungible tokens that are the subject of smart contracts. These drawings in no way limit any changes in form and detail that may be made by one skilled in the art without departing from the spirit and scope of the disclosed implementations.

FIG. 1 shows a system diagram of an example of a system 100 in which trust is ensured throughout the lifecycle of non-fungible tokens, in accordance with some implementations.

FIG. 2 shows a process flow diagram 200 illustrating an example of a method for generating smart contracts, in accordance with some implementations.

FIG. 3 shows a diagram 300 illustrating an example metadata data structure associated with a non-fungible token, in accordance with some implementations.

FIG. 4 shows a diagram 400 illustrating an example modified metadata data structure associated with a non-fungible token, in accordance with some implementations.

FIG. 5 shows a block diagram of an example system in which trust is ensured throughout the lifecycle of non-fungible tokens, in accordance with some implementations.

FIG. 6A shows a block diagram of an example of an environment 10 in which an on-demand database service can be used in accordance with some implementations.

FIG. 6B shows a block diagram of an example of some implementations of elements of FIG. 6A and various possible interconnections between these elements.

FIG. 7A shows a system diagram of an example of architectural components of an on-demand database service environment 900, in accordance with some implementations.

FIG. 7B shows a system diagram further illustrating an example of architectural components of an on-demand database service environment, in accordance with some implementations.

### DETAILED DESCRIPTION

Examples of systems, apparatus, methods and computer program products according to the disclosed implementations are described in this section. These examples are being provided solely to add context and aid in the understanding of the disclosed implementations. It will thus be apparent to one skilled in the art that implementations may be practiced without some or all of these specific details. In other instances, certain operations have not been described in detail to avoid unnecessarily obscuring implementations. Other applications are possible, such that the following examples should not be taken as definitive or limiting either in scope or setting.

In the following detailed description, references are made to the accompanying drawings, which form a part of the description and in which are shown, by way of illustration, specific implementations. Although these implementations are described in sufficient detail to enable one skilled in the art to practice the disclosed implementations, it is understood that these examples are not limiting, such that other implementations may be used and changes may be made without departing from their spirit and scope. For example, the operations of methods shown and described herein are not necessarily performed in the order indicated. It should also be understood that the methods may include more or fewer operations than are indicated. In some implementations, operations described herein as separate operations may be combined. Conversely, what may be described herein as a single operation may be implemented in multiple operations.

An on-demand database system allows entities to store information such as records of transactions. However, in conventional systems, an on-demand database system is typically controlled by a service provider, requiring parties to a transaction recorded in the on-demand database system to trust that the service provider will continue to exist, will maintain an adequate level of security, will not permit the transaction record to be lost or corrupted, and will generally behave in a trustworthy manner.

Techniques and mechanisms described herein provide for interactions between an on-demand database system and a public trust ledger. A public trust ledger provides a way to record transactions in a manner that is secure, publicly verifiable, and free from control of any one entity. For instance, the database system may interact with the public trust ledger to record transactions related to the creation and transfer of ownership and other rights in digital assets referenced within the on-demand database system. The public trust ledger may then serve as a source of truth that it is independent of the service provider. A trust ledger may be variously referred to herein as a public trust ledger or a distributed trust ledger. One example of a public trust ledger is a blockchain.

A non-fungible token (NFT) is a digital asset that links ownership to unique physical or digital items, such as works of art, music, or videos. Current technology enables a non-fungible token to be minted, enabling a corresponding smart contract to be stored in a blockchain. Owners of non-fungible tokens often feel secure since smart contracts are not mutable. Unfortunately, non-fungible tokens that are the subject of these smart contracts are mutable.

According to various embodiments, techniques and mechanisms described herein may facilitate the enhancement of a lifecycle of non-fungible tokens. For instance, an entity accessing services via an on-demand computing services environment can easily and dynamically create any number of non-fungible tokens corresponding with digital assets such as avatars, apparel, characters, promotional material, or any other digital item.

Consider the example of Alexandra, an employee for a company “Acme” accessing computing services via the on-demand database system. Alexandra would like to create a number of non-fungible tokens on a blockchain for purposes such as instituting a customer rewards program, connecting physical and digital products, and building Acme's presence in the metaverse. However, both Acme and Alexandra are concerned about maintaining control and security over the smart contracts and tokens associated with Acme.

There currently fails to be a way to prevent hackers or other individuals from copying, modifying, or deleting a non-fungible token. Therefore, a need exists for enhancing the lifespan of non-fungible tokens.

According to various embodiments, techniques and mechanisms described herein may provide technical solutions that facilitate a variety of ways for organizations and owners to ensure the validity of smart contracts and the integrity of non-fungible tokens (NFTs). For example, an organization may employ branded collectibles represented by digital assets. As another example, an organization may bundle real world and digital experience linked to digital assets. As yet another example, an organization may securely send exclusive codes for benefits such as early access, discounts, VIP tickets, and gift cards. As still another example, an organization may build a loyal base of customers with free or gamified rewards across different use cases.

Some implementations of the disclosed systems, apparatus, methods and computer program products are configured for ensuring that a non-fungible token is trustworthy through the lifecycle of the non-fungible token. These techniques facilitate validating smart contracts, as well as ensuring the integrity of associated non-fungible tokens. These processes may be initiated by a consumer, as well as a brand associated with a non-fungible token or secondary markets. Appropriate action can be taken if a non-fungible token has been modified or otherwise tampered with.

Minting a non-fungible token causes a digital file to be turned into a digital asset that can be stored on the blockchain. Once it has become a digital asset, the non-fungible token can be sold or transferred via smart contract. A smart contract can be stored in the blockchain.

Unfortunately, there fails to be a mechanism for ensuring that a smart contract is valid. Similarly, there is no way to ensure that the non-fungible token is not fraudulent or modified. Therefore, there fails to be a way to ensure trust throughout the lifecycle of a non-fungible token.

In some implementations, the minting of a non-fungible token triggers a process via which a smart contract is stored on a blockchain. This process generates a hash value that is stored in association with the smart contract.

In some implementations, the database system identifies, from a metadata data structure associated with a non-fungible token, a first network address associated with a first attribute of the metadata data structure. The system accesses a first file referenced by the first network address and generates a first hash value from contents of the first file. The system generates a modified metadata data structure that includes the first hash value by storing, within the metadata data structure, the first hash value in association with the first attribute. The system then generates a second hash value using the modified metadata data structure. The system stores, in a block chain, a first smart contract including the second hash value and a second network address that references the modified metadata data structure. The system may then use the second hash value to subsequently attempt to validate a smart contract. For example, the first smart contract may be periodically validated. As another example, a fraudulent smart contract may be proved to be invalid using the second hash value.

In some implementations, hash values are not stored in association with some smart contracts. In these instances, image analysis may be performed to ensure that a token associated with a smart contract has not been fraudulently copied, modified or replaced.

In some implementations, in the event that a fraudulent smart contract or token is detected, a notification may be transmitted to the owner of the smart contract. In addition, a notification may be transmitted to further entities, such as a brand owner or insurance company with which the owner of the smart contract has a policy.

In particular embodiments, a database system service provider may employ a technology to facilitate interactions with a public trust ledger. In such an approach, the service provider may perform operations such as validation and minting within its own blockchain. Then, transactions may be recorded in a widely available public blockchain such as Ethereum.

As used herein, the terms “database” and “public trust ledger” are distinct. For example, a database system is controlled by a particular database administrator or service provider, whereas a public trust ledger or blockchain is a peer-to-peer system in which transactions are publicly recorded in a manner that is outside the control of any one particular organization.

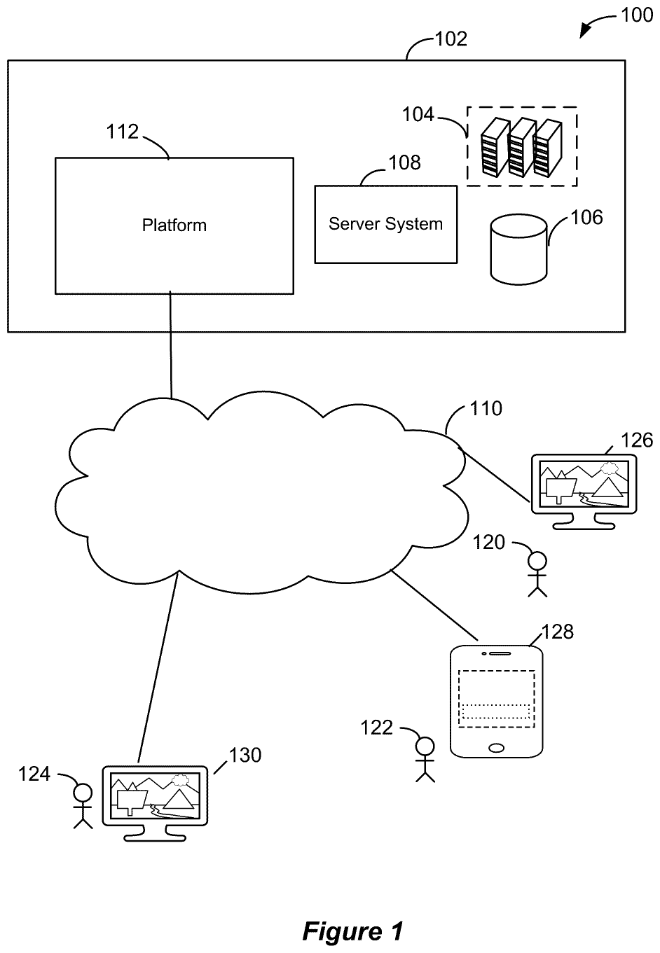

FIG. 1 shows a system diagram of an example of a system 100 in which trust may be ensured throughout the lifecycle of a non-fungible token, in accordance with some implementations. Database system 102 includes a variety of different hardware and/or software components that are in communication with each other. In the non-limiting example of FIG. 1, system 102 includes any number of computing devices such as servers 104. Server system 108 including servers 104 is in communication with one or more storage mediums 106 configured to store and maintain relevant metadata used to perform some of the techniques disclosed herein, as well as to store and maintain relevant data and/or metadata generated by the techniques disclosed herein. Storage mediums 106 may further store computer-readable instructions configured to perform some of the techniques described herein. Storage mediums 106 can store files or information pertaining to features of tokens and/or smart contracts, which may be updated and accessed as described in further detail below.

In some implementations, system 102 is configured to store user profiles/user accounts associated with users of system 102. Information maintained in a user account (e.g., email account) of a user can include or indicate a user email address and credentials of the user. For example, credentials of the user can include a username and password.

Client devices 126, 128 may be in communication with system 102 via network 122. More particularly, client devices 126, 128 may communicate with servers 104 via network 122. For example, network 122 can be the Internet. In another example, network 122 comprises one or more local area networks (LAN) in communication with one or more wide area networks (WAN) such as the Internet.

Embodiments described herein are often implemented in a cloud computing environment, in which network 122, servers 104, and possible additional apparatus and systems such as multi-tenant databases may all be considered part of the “cloud.” Servers 104 may be associated with a network domain, such as www.salesforce.com and may be controlled by a data provider associated with the network domain. A user of client computing device 126 can have an account at Salesforce.com®.

In some implementations, users 120, 122 of client devices 126, 128 can access services by logging into system 102 via platform 124. More particularly, client devices 126, 128 can log into system 102 via an application programming interface (API) or via a graphical user interface (GUI) using credentials of corresponding users 120, 122, respectively. Services can include, for example, validation of smart contracts, minting of non-fungible tokens, etc.

Examples of devices used by users include, but are not limited to a desktop computer or portable electronic device such as a smartphone, a tablet, a laptop, a wearable device such as Google Glass®, another optical head-mounted display (OHMD) device, a smart watch, etc.

In some implementations, system 102 supports the validation of smart contracts and/or verification of integrity of tokens that are the subject of smart contracts. Validation and/or verification may be initiated via a user, a company, or a system-initiated process. For example, validation and/or verification can be initiated via an application programming interface (API), which can be called by an action initiated by a user, a process, or a system that is external to system 102.

In some implementations, the system transmits a notification message of failed validation of a smart contract or failed verification of a token. The notification can be transmitted to an owner of the pertinent smart contract/token, a company or brand that generated the token, and/or another entity.

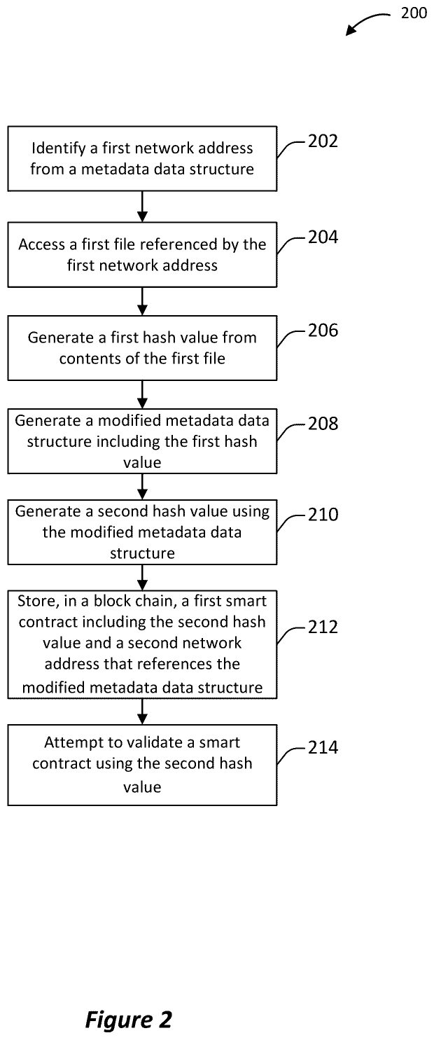

FIG. 2 shows a process flow diagram 200 illustrating an example of a method for generating smart contracts, in accordance with some implementations. In some implementations, the database system identifies at 202, from a metadata data structure associated with a non-fungible token, a first network address associated with a first attribute of the metadata data structure. The system accesses a first file referenced by the first network address at 204 and generates a first hash value from contents of the first file at 206. The system generates a modified metadata data structure that includes the first hash value at 208 by storing, within the metadata data structure, the first hash value in association with the first attribute.

In addition, in some implementations, a contract identifier or contract address is added as an attribute to the metadata data structure. This contract identifier/address can be used to verify the validity of a smart contract via a lookup in a verification site maintained for a brand or other entity.

The system then generates a second hash value using the modified metadata data structure at 210. The system stores, in a block chain, a smart contract. The first smart contract includes a smart contract identifier, the second hash value and a second network address that references the modified metadata data structure at 212. The smart contract can also include an owner identifier, as well as additional information such as a public and private key.

The system may then use the second hash value to subsequently attempt to validate a smart contract at 214. For example, a second, fraudulent smart contract that is allegedly the same as the first smart contract may be proved to be invalid using the second hash value. Since the correct hash value of the first smart contract is known, it is possible to quickly ascertain whether the newly generated second hash value of the smart contract is not correct.

In some implementations, the smart contract can be validated in response to a user-initiated action. Alternatively, the smart contract can be validated in response to a command received from an internal or external process. For example, an application programming interface (API) may enable an external process or user to initiate a smart contract validation process.

In some implementations, the system automatically periodically tests the integrity of the smart contract and associated non-fungible token by accessing the corresponding metadata structure and re-generating the second hash value. If the second hash value has changed, the system can transmit a notification to the owner of the non-fungible token, as well as other pertinent parties, as appropriate. For example, a notification can be transmitted to a pertinent entity (e.g., brand or company) that generated the non-fungible token or an insurance company with which the owner of the token has an insurance contract for the non-fungible token.

In some implementations, in the event that the non-fungible token has been tampered with or becomes corrupted, the system can recover the non-fungible token by accessing the token from a repository in another location and replaces the modified token with the recovered token at the location defined by the network address within the modified metadata data structure.

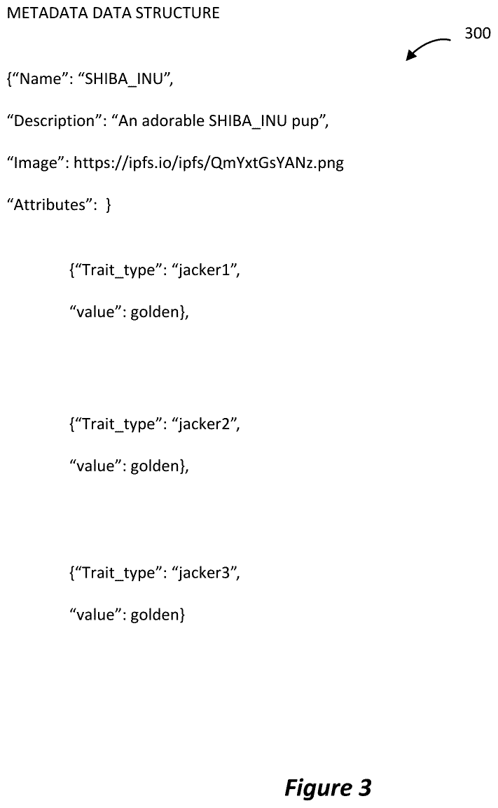

FIG. 3 shows a diagram 300 illustrating an example metadata data structure associated with a non-fungible token, in accordance with some implementations. As shown in this example, the metadata data structure includes an identifier/name of a non-fungible token, an optional description, and a network address associated with a file. In this example, the file is an image file. However, it is possible for the file to be an executable file, video file, audio file, or other type of file. The metadata data structure also includes a set of attributes associated with the token. Such metadata data structure may be specified in any suitable format, such as JSON or XML.

According to various embodiments, the metadata data structure may include one or more attributes of a corresponding token. For instance, in the case of an non-fungible token, the token metadata may identify unique characteristics of the non-fungible token. In some configurations, token metadata may include a reference to information stored outside the blockchain. For example, the token metadata may include a URI or other identifier associated with information stored in the InterPlanetary File System (IPFS), Filecoin, or other distributed storage system. As another example, the token metadata may include a URI or other identifier associated with information stored elsewhere in the same or a different blockchain. As another example, the token metadata may include a URI or other identifier associated with information stored in a different location, such as YouTube.

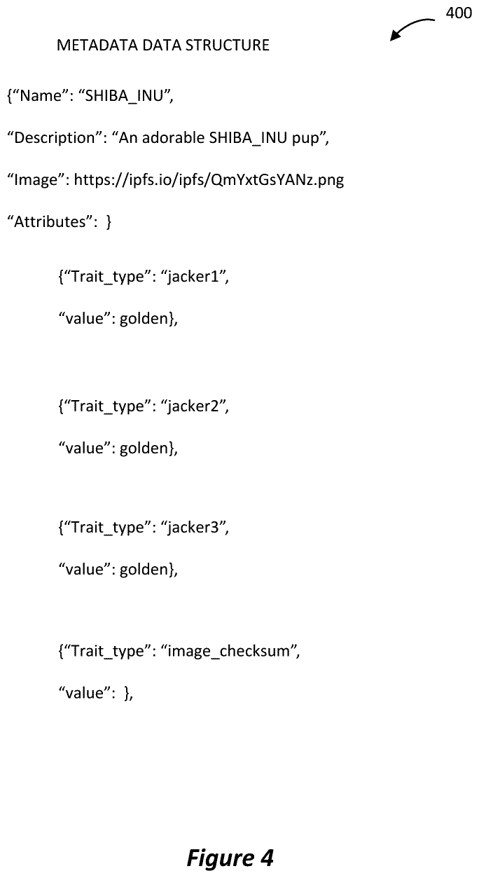

FIG. 4 shows a diagram 400 illustrating an example modified metadata data structure associated with a non-fungible token, in accordance with some implementations. As shown in this example, the set of attributes includes an additional attribute, which is a checksum of the contents of the file. The value of the additional attribute is a checksum value.

In some implementations, an additional contract address is added as an attribute of the modified metadata data structure (not shown). This contract address can be used via a lookup in a brand database to verify that the smart contract is a valid smart contract.

Once the modified metadata data structure has been generated, a second checksum of the entire modified metadata data structure is generated. Within the block chain, an entry includes an identifier of the smart contract, a network address (e.g., link) referencing the modified metadata data structure, and the second hash value.

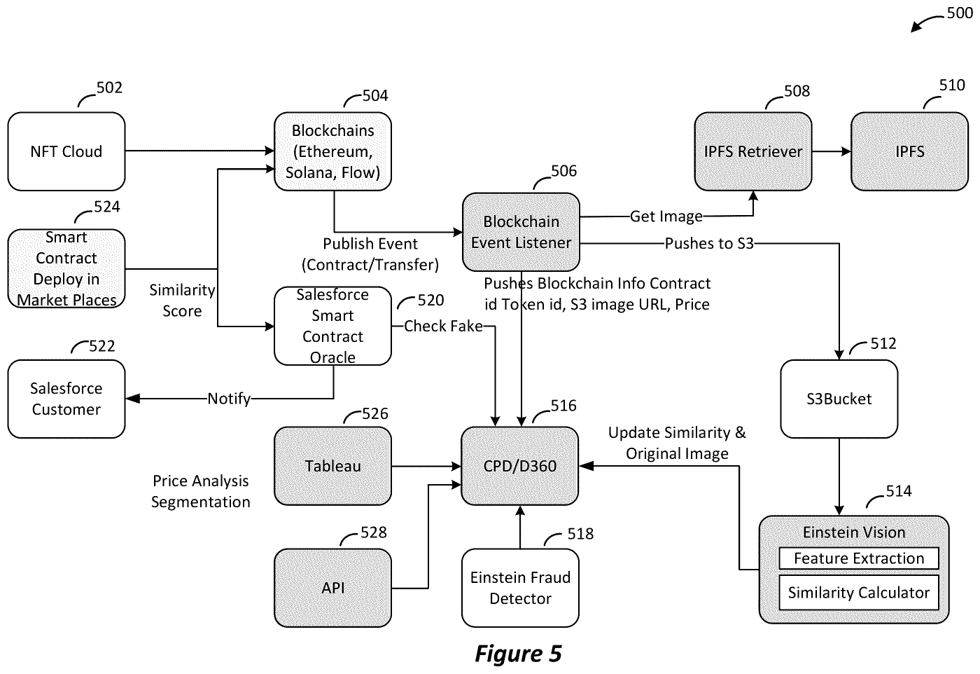

In accordance with various implementations, a database system enables individuals, brands, and secondary parties to ensure the trustworthiness of non-fungible tokens. FIG. 5 shows a block diagram of an example system 500 in which the trust is ensured throughout the lifecycle of non-fungible tokens, in accordance with some implementations.

System 500 may be used to implement techniques described herein. System 500 includes a public trust ledger (i.e., blockchain) 504. According to various embodiments, the public trust ledger 504 may store information related to digital assets and transactions pertaining to digital assets. The public trust ledger 504 may be cryptographically verifiable. For example, the public trust ledger may employ one or more cryptographic technologies to provide a transparent, immutable, and cryptographically-verifiable log of transactions stored in the database.

In accordance with various implementations, a “customer” (e.g., an individual, a brand, or a company) signs up for service with NFT cloud 502. This enables the customer to mint non-fungible tokens, as well as ensure that their tokens are trustworthy.

When a user or system process mints a non-fungible token, via the NFT cloud 502, the NFT cloud 502 “converts” the non-fungible token into digital assets stored on a blockchain 504. In addition, the system may publish an event that indicates that a non-fungible token has been minted such that digital assets are stored on the blockchain. For example, the event that is published can include information from the metadata data structure.

At the time that the token is minted, the pertinent file (e.g, image file) and associated metadata can be uploaded by NFT cloud 502 to an Interplanetary File System (IPFS). For example, a JSON file containing the metadata can be automatically generated. The NFT cloud 502 accesses the JSON file, generates a hash value as described above and stores the hash value in a corresponding smart contract on the block chain 504. As described above, the smart contract includes an identifier, a link (e.g., URL) to the metadata, and the generated hash value.

As described above, the metadata can include a token identifier. According to various embodiments, a token identifier is an identifier created when the token is minted. The token identifier uniquely identifies the token within the public trust ledger. A token type specified in the metadata data structure indicates the type of token represented by the token.

In some implementations, a smart contract may include a single token. Alternatively, a smart contract may include more than one token. For example, the ERC-1155 standard as well as other types of token standards provide for multiple tokens within the same smart contract.

In some embodiments, the token may be non-fungible. However, as discussed herein, techniques and mechanisms described herein may also be used in conjunction with fungible tokens.

In some implementations, the smart contract 500 is a computer program that may be included within a public trust ledger such as a blockchain. The smart contract may then be executed to perform one or more operations.

According to various embodiments, the smart contract includes an owner identifier that identifies the owner of the smart contract and the associated one or more tokens. The owner identifier may indicate an account in the public trust ledger. By authenticating as the owner associated with the owner ID, the owner may be able to authorize one or more transactions associated with the smart contract, such as recording a transaction transferring the associated token to a different party.

A blockchain event listener 506 may subscribe to the event and therefore be notified of the published event. The published event can include relevant information for the smart contract (e.g., owner of the token, contract identifier, token identifier, network address (e.g., URL) of the non-fungible token (e.g., image), attributes, etc.). Blockchain event listener 506 may use the network address to retrieve the corresponding non-fungible token or file (e.g., image) from a file system. For example, blockchain event listener 506 may access a gateway such as an IPFS (Interplanetary File System) gateway 508 to retrieve the file (e.g., image) from the IPFS 510. Blockchain event listener 506 may then push the file to storage 512.

Blockchain event listener 506 may push blockchain information it has received in the published event to customer data platform 516. For example, the blockchain information can include, but is not limited to, a smart contract identifier, a token identifier, and an image network address (e.g., URL). Customer data platform 516 may store this information for a customer/brand. In some implementations, customer data platform 516 includes a multi-tenant database system that stores information for multiple brands, where each brand is associated with a tenant of the multi-tenant database system.

A computer vision module 514 can extract features from the image and compare the features with those of other non-fungible tokens using information stored in customer data platform 516. Similarity may be determined using a machine learning algorithm. In some implementations, similarity between attributes of the image and other non-fungible tokens stored in customer data platform 516 is determined.

A fraud detector 518 may determine, from similarity score(s) indicating a similarity between the non-fungible token and other non-fungible token(s), whether the non-fungible token is the same as another token or has a similarity that exceeds a similarity threshold. For example, a token generated by a brand may be the same as another token, and therefore the second token is determined to be a fake. As another example, a fake token may be a copy that is a different color (e.g., green) from that of the “authentic” token (e.g., blue), resulting in a similarity score that is 95%.

Fraud detector 518 can store information identifying tokens that are likely to be fraudulent to the customer data platform 516. For example, a token may be flagged as fraudulent and/or a similarity score may be stored in association with the token.

A smart contract may be deployed in secondary markets 524. In the event that the smart contract has an associated hash value, it can be compared by smart contract oracle 520 to hash values of other smart contracts to identify a potential fake token. Thus, smart contract oracle 520 can verify, for a smart contract, that the checksum matches a previously stored checksum for the smart contract. Alternatively, if the smart contract does not have an associated hash value, the file can be processed as set forth above to identify fraudulent tokens.

Smart contract oracle 520 may identify those tokens and/or smart contracts that have been flagged as being fraudulent or likely to be fraudulent and notify the pertinent entity or entities 522. For example, the brand that generated the token may be notified of the token(s) that have been identified as fraudulent or likely to be fraudulent. As another example, the owner of the token may be notified that their token is a copy of an original token and is not an authentic token.

A segmentation module 526 can segment smart contracts and/or tokens according to various criteria, including those that are fraudulent or likely to be fraudulent.

In some implementations, an application programming interface (API) 528 enables a user or external system to access the system to determine whether a non-fungible token is fake or likely to be fake. In this manner, it is possible for brands and secondary markets to ensure that a non-fungible token is authentic and has not been tampered with.

In some implementations, the smart contract can automatically call an API to determine whether it is authentic. More particularly, the smart contract can include computer-readable instructions that periodically call the API to verify the smart contract has not been tampered with or otherwise modified.

Some but not all of the techniques described or referenced herein are implemented using or in conjunction with a database system, which may be include a multi-tenant database system. The term “multi-tenant database system” generally refers to those systems in which various elements of hardware and/or software of a database system may be shared by one or more customers.

Some non-limiting examples of systems, apparatus, and methods are described below for implementing database systems in conjunction with the disclosed techniques. Such implementations can provide more efficient use of a database system.

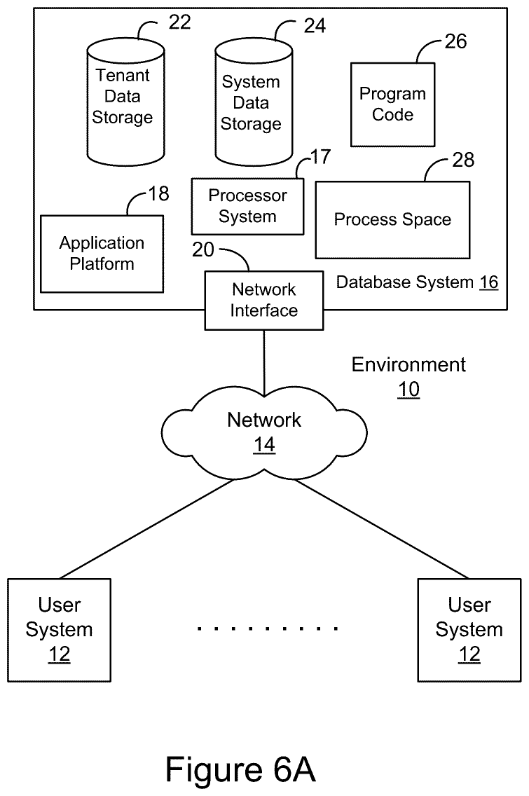

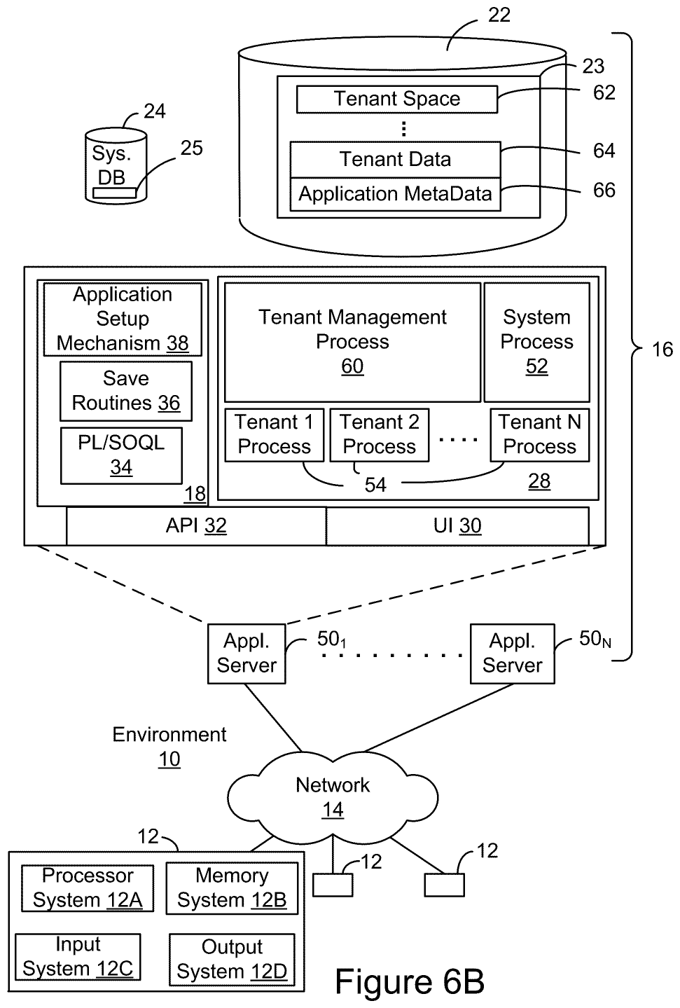

FIG. 6A shows a block diagram of an example of an environment 10 in which an on-demand database service exists and can be used in accordance with some implementations. Environment 10 may include user systems 12, network 14, database system 16, processor system 17, application platform 18, network interface 20, tenant data storage 22, system data storage 24, program code 26, and process space 28. In other implementations, environment 10 may not have all of these components and/or may have other components instead of, or in addition to, those listed above.

A user system 12 may be implemented as any computing device(s) or other data processing apparatus such as a machine or system used by a user to access a database system 16. For example, any of user systems 12 can be a handheld and/or portable computing device such as a mobile phone, a smartphone, a laptop computer, or a tablet. Other examples of a user system include computing devices such as a work station and/or a network of computing devices. As illustrated in FIG. 6A (and in more detail in FIG. 6B) user systems 12 might interact via a network 14 with an on-demand database service, which is implemented in the example of FIG. 6A as database system 16.

An on-demand database service, implemented using system 16 by way of example, is a service that is made available to users who do not need to necessarily be concerned with building and/or maintaining the database system. Instead, the database system may be available for their use when the users need the database system, i.e., on the demand of the users. Some on-demand database services may store information from one or more tenants into tables of a common database image to form a multi-tenant database system (MTS). A database image may include one or more database objects. A relational database management system (RDBMS) or the equivalent may execute storage and retrieval of information against the database object(s). Application platform 18 may be a framework that allows the applications of system 16 to run, such as the hardware and/or software, e.g., the operating system. In some implementations, application platform 18 enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, when a salesperson is using a particular user system 12 to interact with system 16, the user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level, also called authorization.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. Network 14 can include a TCP/IP (Transfer Control Protocol and Internet Protocol) network, such as the global internetwork of networks often referred to as the Internet. The Internet will be used in many of the examples herein. However, it should be understood that the networks that the present implementations might use are not so limited.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP signals to and from an HTTP server at system 16. Such an HTTP server might be implemented as the sole network interface 20 between system 16 and network 14, but other techniques might be used as well or instead. In some implementations, the network interface 20 between system 16 and network 14 includes load sharing functionality, such as round-robin HTTP request distributors to balance loads and distribute incoming HTTP requests evenly over a plurality of servers. At least for users accessing system 16, each of the plurality of servers has access to the MTS' data; however, other alternative configurations may be used instead.

In one implementation, system 16, shown in FIG. 6A, implements a web-based CRM system. For example, in one implementation, system 16 includes application servers configured to implement and execute CRM software applications as well as provide related data, code, forms, web pages and other information to and from user systems 12 and to store to, and retrieve from, a database system related data, objects, and Webpage content. With a multi-tenant system, data for multiple tenants may be stored in the same physical database object in tenant data storage 22, however, tenant data typically is arranged in the storage medium(s) of tenant data storage 22 so that data of one tenant is kept logically separate from that of other tenants so that one tenant does not have access to another tenant's data, unless such data is expressly shared. In certain implementations, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

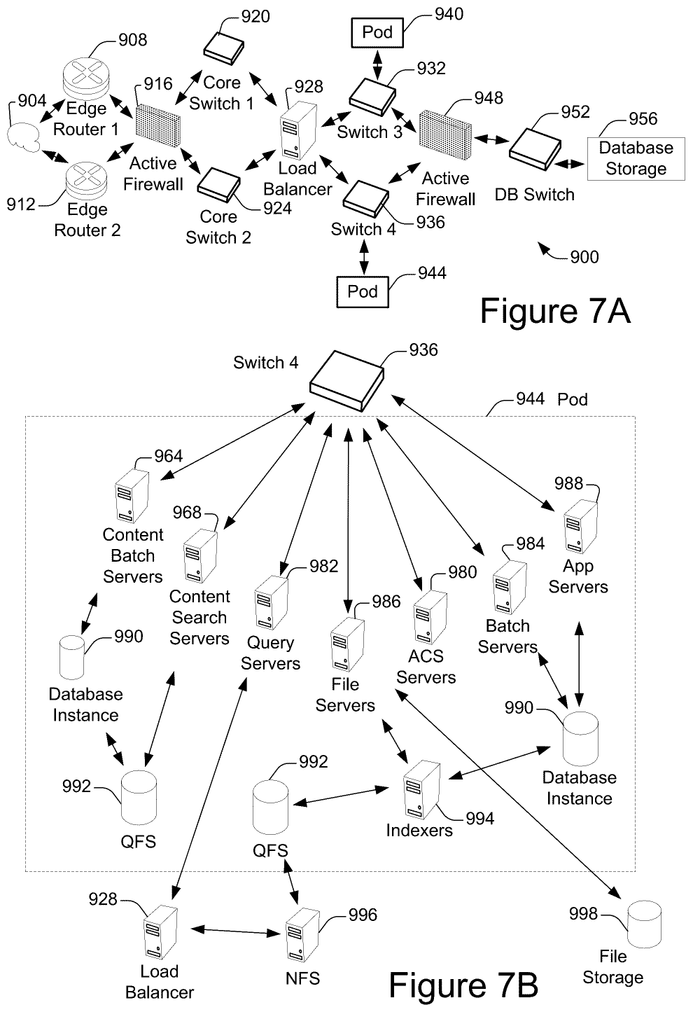

One arrangement for elements of system 16 is shown in FIGS. 7A and 7B, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 6A include conventional, well-known elements that are explained only briefly here. For example, each user system 12 could include a desktop personal computer, workstation, laptop, PDA, cell phone, or any wireless access protocol (WAP) enabled device or any other computing device capable of interfacing directly or indirectly to the Internet or other network connection. The term “computing device” is also referred to herein simply as a “computer”. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user input devices, such as a keyboard, a mouse, trackball, touch pad, touch screen, pen or the like, for interacting with a GUI provided by the browser on a display (e.g., a monitor screen, LCD display, OLED display, etc.) of the computing device in conjunction with pages, forms, applications and other information provided by system 16 or other systems or servers. Thus, “display device” as used herein can refer to a display of a computer system such as a monitor or touch-screen display, and can refer to any computing device having display capabilities such as a desktop computer, laptop, tablet, smartphone, a television set-top box, or wearable device such Google Glass® or other human body-mounted display apparatus. For example, the display device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

According to one implementation, each user system 12 and all of its components are operator configurable using applications, such as a browser, including computer code run using a central processing unit such as an Intel Pentium® processor or the like. Similarly, system 16 (and additional instances of an MTS, where more than one is present) and all of its components might be operator configurable using application(s) including computer code to run using processor system 17, which may be implemented to include a central processing unit, which may include an Intel Pentium® processor or the like, and/or multiple processor units. Non-transitory computer-readable media can have instructions stored thereon/in, that can be executed by or used to program a computing device to perform any of the methods of the implementations described herein. Computer program code 26 implementing instructions for operating and configuring system 16 to intercommunicate and to process web pages, applications and other data and media content as described herein is preferably downloadable and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any other type of computer-readable medium or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for the disclosed implementations can be realized in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to refer to one type of computing device such as a system including processing hardware and process space(s), an associated storage medium such as a memory device or database, and, in some instances, a database application (e.g., OODBMS or RDBMS) as is well known in the art. It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

FIG. 6B shows a block diagram of an example of some implementations of elements of FIG. 6A and various possible interconnections between these elements. That is, FIG. 6B also illustrates environment 10. However, in FIG. 6B elements of system 16 and various interconnections in some implementations are further illustrated. FIG. 6B shows that user system 12 may include processor system 12A, memory system 12B, input system 12C, and output system 12D. FIG. 6B shows network 14 and system 16. FIG. 6B also shows that system 16 may include tenant data storage 22, tenant data 23, system data storage 24, system data 25, User Interface (UI) 30, Application Program Interface (API) 32, PL/SOQL 34, save routines 36, application setup mechanism 38, application servers 50₁-50_{N}, system process space 52, tenant process spaces 54, tenant management process space 60, tenant storage space 62, user storage 64, and application metadata 66. In other implementations, environment 10 may not have the same elements as those listed above and/or may have other elements instead of, or in addition to, those listed above.

User system 12, network 14, system 16, tenant data storage 22, and system data storage 24 were discussed above in FIG. 6A. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 6B, system 16 may include a network interface 20 (of FIG. 6A) implemented as a set of application servers 50, an application platform 18, tenant data storage 22, and system data storage 24. Also shown is system process space 52, including individual tenant process spaces 54 and a tenant management process space 60. Each application server 50 may be configured to communicate with tenant data storage 22 and the tenant data 23 therein, and system data storage 24 and the system data 25 therein to serve requests of user systems 12. The tenant data 23 might be divided into individual tenant storage spaces 62, which can be either a physical arrangement and/or a logical arrangement of data. Within each tenant storage space 62, user storage 64 and application metadata 66 might be similarly allocated for each user. For example, a copy of a user's most recently used (MRU) items might be stored to user storage 64. Similarly, a copy of MRU items for an entire organization that is a tenant might be stored to tenant storage space 62. A UI 30 provides a user interface and an API 32 provides an application programmer interface to system 16 resident processes to users and/or developers at user systems 12. The tenant data and the system data may be stored in various databases, such as one or more Oracle® databases.

Application platform 18 includes an application setup mechanism 38 that supports application developers' creation and management of applications, which may be saved as metadata into tenant data storage 22 by save routines 36 for execution by subscribers as one or more tenant process spaces 54 managed by tenant management process 60 for example. Invocations to such applications may be coded using PL/SOQL 34 that provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes, which manage retrieving application metadata 66 for the subscriber making the invocation and executing the metadata as an application in a virtual machine.

Each application server 50 may be communicably coupled to database systems, e.g., having access to system data 25 and tenant data 23, via a different network connection. For example, one application server 50₁ might be coupled via the network 14 (e.g., the Internet), another application server 50_{N-1} might be coupled via a direct network link, and another application server 50_{N} might be coupled by yet a different network connection. Transfer Control Protocol and Internet Protocol (TCP/IP) are typical protocols for communicating between application servers 50 and the database system. However, it will be apparent to one skilled in the art that other transport protocols may be used to optimize the system depending on the network interconnect used.

In certain implementations, each application server 50 is configured to handle requests for any user associated with any organization that is a tenant. Because it is desirable to be able to add and remove application servers from the server pool at any time for any reason, there is preferably no server affinity for a user and/or organization to a specific application server 50. In one implementation, therefore, an interface system implementing a load balancing function (e.g., an F5 Big-IP load balancer) is communicably coupled between the application servers 50 and the user systems 12 to distribute requests to the application servers 50. In one implementation, the load balancer uses a least connections algorithm to route user requests to the application servers 50. Other examples of load balancing algorithms, such as round robin and observed response time, also can be used. For example, in certain implementations, three consecutive requests from the same user could hit three different application servers 50, and three requests from different users could hit the same application server 50. In this manner, by way of example, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain implementations, user systems 12 (which may be client systems) communicate with application servers 50 to request and update system-level and tenant-level data from system 16 that may involve sending one or more queries to tenant data storage 22 and/or system data storage 24. System 16 (e.g., an application server 50 in system 16) automatically generates one or more SQL statements (e.g., one or more SQL queries) that are designed to access the desired information. System data storage 24 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In certain implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

FIG. 7A shows a system diagram of an example of architectural components of an on-demand database service environment 900, in accordance with some implementations. A client machine located in the cloud 904, generally referring to one or more networks in combination, as described herein, may communicate with the on-demand database service environment via one or more edge routers 908 and 912. A client machine can be any of the examples of user systems 12 described above. The edge routers may communicate with one or more core switches 920 and 924 via firewall 916. The core switches may communicate with a load balancer 928, which may distribute server load over different pods, such as the pods 940 and 944. The pods 940 and 944, which may each include one or more servers and/or other computing resources, may perform data processing and other operations used to provide on-demand services. Communication with the pods may be conducted via pod switches 932 and 936. Components of the on-demand database service environment may communicate with a database storage 956 via a database firewall 948 and a database switch 952.

As shown in FIGS. 7A and 7B, accessing an on-demand database service environment may involve communications transmitted among a variety of different hardware and/or software components. Further, the on-demand database service environment 900 is a simplified representation of an actual on-demand database service environment. For example, while only one or two devices of each type are shown in FIGS. 7A and 7B, some implementations of an on-demand database service environment may include anywhere from one to many devices of each type. Also, the on-demand database service environment need not include each device shown in FIGS. 7A and 7B, or may include additional devices not shown in FIGS. 7A and 7B.

Moreover, one or more of the devices in the on-demand database service environment 900 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 904 is intended to refer to a data network or combination of data networks, often including the Internet. Client machines located in the cloud 904 may communicate with the on-demand database service environment to access services provided by the on-demand database service environment. For example, client machines may access the on-demand database service environment to retrieve, store, edit, and/or process information.

In some implementations, the edge routers 908 and 912 route packets between the cloud 904 and other components of the on-demand database service environment 900. The edge routers 908 and 912 may employ the Border Gateway Protocol (BGP). The BGP is the core routing protocol of the Internet. The edge routers 908 and 912 may maintain a table of IP networks or ‘prefixes’, which designate network reachability among autonomous systems on the Internet.

In one or more implementations, the firewall 916 may protect the inner components of the on-demand database service environment 900 from Internet traffic. The firewall 916 may block, permit, or deny access to the inner components of the on-demand database service environment 900 based upon a set of rules and other criteria. The firewall 916 may act as one or more of a packet filter, an application gateway, a stateful filter, a proxy server, or any other type of firewall.

In some implementations, the core switches 920 and 924 are high-capacity switches that transfer packets within the on-demand database service environment 900. The core switches 920 and 924 may be configured as network bridges that quickly route data between different components within the on-demand database service environment. In some implementations, the use of two or more core switches 920 and 924 may provide redundancy and/or reduced latency.

In some implementations, the pods 940 and 944 may perform the core data processing and service functions provided by the on-demand database service environment. Each pod may include various types of hardware and/or software computing resources. An example of the pod architecture is discussed in greater detail with reference to FIG. 7B.

In some implementations, communication between the pods 940 and 944 may be conducted via the pod switches 932 and 936. The pod switches 932 and 936 may facilitate communication between the pods 940 and 944 and client machines located in the cloud 904, for example via core switches 920 and 924. Also, the pod switches 932 and 936 may facilitate communication between the pods 940 and 944 and the database storage 956.

In some implementations, the load balancer 928 may distribute workload between the pods 940 and 944. Balancing the on-demand service requests between the pods may assist in improving the use of resources, increasing throughput, reducing response times, and/or reducing overhead. The load balancer 928 may include multilayer switches to analyze and forward traffic.

In some implementations, access to the database storage 956 may be guarded by a database firewall 948. The database firewall 948 may act as a computer application firewall operating at the database application layer of a protocol stack. The database firewall 948 may protect the database storage 956 from application attacks such as structure query language (SQL) injection, database rootkits, and unauthorized information disclosure.

In some implementations, the database firewall 948 may include a host using one or more forms of reverse proxy services to proxy traffic before passing it to a gateway router. The database firewall 948 may inspect the contents of database traffic and block certain content or database requests. The database firewall 948 may work on the SQL application level atop the TCP/IP stack, managing applications' connection to the database or SQL management interfaces as well as intercepting and enforcing packets traveling to or from a database network or application interface.

In some implementations, communication with the database storage 956 may be conducted via the database switch 952. The multi-tenant database storage 956 may include more than one hardware and/or software components for handling database queries. Accordingly, the database switch 952 may direct database queries transmitted by other components of the on-demand database service environment (e.g., the pods 940 and 944) to the correct components within the database storage 956.

In some implementations, the database storage 956 is an on-demand database system shared by many different organizations. The on-demand database service may employ a multi-tenant approach, a virtualized approach, or any other type of database approach. On-demand database services are discussed in greater detail with reference to FIGS. 7A and 7B.

FIG. 7B shows a system diagram further illustrating an example of architectural components of an on-demand database service environment, in accordance with some implementations. The pod 944 may be used to render services to a user of the on-demand database service environment 900. In some implementations, each pod may include a variety of servers and/or other systems. The pod 944 includes one or more content batch servers 964, content search servers 968, query servers 982, file servers 986, access control system (ACS) servers 980, batch servers 984, and app servers 988. Also, the pod 944 includes database instances 990, quick file systems (QFS) 992, and indexers 994. In one or more implementations, some or all communication between the servers in the pod 944 may be transmitted via the switch 936.

The content batch servers 964 may handle requests internal to the pod. These requests may be long-running and/or not tied to a particular customer. For example, the content batch servers 964 may handle requests related to log mining, cleanup work, and maintenance tasks.

The content search servers 968 may provide query and indexer functions. For example, the functions provided by the content search servers 968 may allow users to search through content stored in the on-demand database service environment.

The file servers 986 may manage requests for information stored in the file storage 998. The file storage 998 may store information such as documents, images, and basic large objects (BLOB s). By managing requests for information using the file servers 986, the image footprint on the database may be reduced.

The query servers 982 may be used to retrieve information from one or more file systems. For example, the query system 982 may receive requests for information from the app servers 988 and then transmit information queries to the NFS 996 located outside the pod.

The pod 944 may share a database instance 990 configured as a multi-tenant environment in which different organizations share access to the same database. Additionally, services rendered by the pod 944 may call upon various hardware and/or software resources. In some implementations, the ACS servers 980 may control access to data, hardware resources, or software resources.

In some implementations, the batch servers 984 may process batch jobs, which are used to run tasks at specified times. Thus, the batch servers 984 may transmit instructions to other servers, such as the app servers 988, to trigger the batch jobs.

In some implementations, the QFS 992 may be an open source file system available from Sun Microsystems® of Santa Clara, California. The QFS may serve as a rapid-access file system for storing and accessing information available within the pod 944. The QFS 992 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 968 and/or indexers 994 to identify, retrieve, move, and/or update data stored in the network file systems 996 and/or other storage systems.

In some implementations, one or more query servers 982 may communicate with the NFS 996 to retrieve and/or update information stored outside of the pod 944.

The NFS 996 may allow servers located in the pod 944 to access information to access files over a network in a manner similar to how local storage is accessed.

In some implementations, queries from the query servers 922 may be transmitted to the NFS 996 via the load balancer 928, which may distribute resource requests over various resources available in the on-demand database service environment. The NFS 996 may also communicate with the QFS 992 to update the information stored on the NFS 996 and/or to provide information to the QFS 992 for use by servers located within the pod 944.

In some implementations, the pod may include one or more database instances 990. The database instance 990 may transmit information to the QFS 992. When information is transmitted to the QFS, it may be available for use by servers within the pod 944 without using an additional database call.

In some implementations, database information may be transmitted to the indexer 994. Indexer 994 may provide an index of information available in the database 990 and/or QFS 992. The index information may be provided to file servers 986 and/or the QFS 992.

In some implementations, one or more application servers or other servers described above with reference to FIGS. 7A and 7B include a hardware and/or software framework configurable to execute procedures using programs, routines, scripts, etc. Thus, in some implementations, one or more of application servers 50₁-50_{N} of FIG. 7B can be configured to initiate performance of one or more of the operations described above by instructing another computing device to perform an operation. In some implementations, one or more application servers 50₁-50_{N} carry out, either partially or entirely, one or more of the disclosed operations. In some implementations, app servers 988 of FIG. 7B support the construction of applications provided by the on-demand database service environment 900 via the pod 944. Thus, an app server 988 may include a hardware and/or software framework configurable to execute procedures to partially or entirely carry out or instruct another computing device to carry out one or more operations disclosed herein. In alternative implementations, two or more app servers 988 may cooperate to perform or cause performance of such operations. Any of the databases and other storage facilities described above with reference to FIGS. 6A, 6B, 7A and 7B can be configured to store lists, articles, documents, records, files, and other objects for implementing the operations described above. For instance, lists of available communication channels associated with share actions for sharing a type of data item can be maintained in tenant data storage 22 and/or system data storage 24 of FIGS. 7A and 7B. By the same token, lists of default or designated channels for particular share actions can be maintained in storage 22 and/or storage 24. In some other implementations, rather than storing one or more lists, articles, documents, records, and/or files, the databases and other storage facilities described above can store pointers to the lists, articles, documents, records, and/or files, which may instead be stored in other repositories external to the systems and environments described above with reference to FIGS. 6A, 6B, 7A and 7B.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of the implementations claimed.

It should be understood that some of the disclosed implementations can be embodied in the form of control logic using hardware and/or computer software in a modular or integrated manner. Other ways and/or methods are possible using hardware and a combination of hardware and software.

Any of the disclosed implementations may be embodied in various types of hardware, software, firmware, and combinations thereof. For example, some techniques disclosed herein may be implemented, at least in part, by computer-readable media that include program instructions, state information, etc., for performing various services and operations described herein. Examples of program instructions include both machine code, such as produced by a compiler, and files containing higher-level code that may be executed by a computing device such as a server or other data processing apparatus using an interpreter. Examples of computer-readable media include, but are not limited to: magnetic media such as hard disks, floppy disks, and magnetic tape; optical media such as flash memory, compact disk (CD) or digital versatile disk (DVD); magneto-optical media; and hardware devices specially configured to store program instructions, such as read-only memory (ROM) devices and random access memory (RAM) devices. A computer-readable medium may be any combination of such storage devices.

Any of the operations and techniques described in this application may be implemented as software code to be executed by a processor using any suitable computer language such as, for example, Java, C++ or Perl using, for example, object-oriented techniques. The software code may be stored as a series of instructions or commands on a computer-readable medium. Computer-readable media encoded with the software/program code may be packaged with a compatible device or provided separately from other devices (e.g., via Internet download). Any such computer-readable medium may reside on or within a single computing device or an entire computer system, and may be among other computer-readable media within a system or network. A computer system or computing device may include a monitor, printer, or other suitable display for providing any of the results mentioned herein to a user.

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. A system comprising:
a database system implemented using a server system, the database system configurable to cause:
identifying, from a metadata data structure associated with a non-fungible token, a first network address associated with a first attribute of the metadata data structure;
accessing a first file referenced by the first network address;
generating a first hash value from contents of the first file;
generating a modified metadata data structure that includes the first hash value by storing, within the metadata data structure, the first hash value in association with the first attribute;
generating a second hash value using the modified metadata data structure;
storing, in a public trust ledger, a first smart contract including the second hash value and a second network address that references the modified metadata data structure; and
attempting to validate a smart contract based, at least in part, on the second hash value.

2. The system of claim 1, the database system configurable to cause:
attempting to validate the smart contract by comparing the second hash value with a third hash value associated with the smart contract; and
transmitting a notification according to a result of attempting to validate the smart contract.

3. The system of claim 1, wherein attempting to validate the smart contract comprises:
for the smart contract, identifying a second network address associated with the first attribute of the associated second metadata data structure;
generating a file hash value using contents of a file referenced by the second network address;
modifying the second metadata data structure by storing the file hash value in association with the first attribute within the second metadata data structure;
generating a second temporary hash value using the modified second metadata data structure; and
determining whether the second temporary hash value is equal to the second hash value.

4. The system of claim 1, the database system further configurable to cause:
calling an application programming interface (API) via which the system attempts to validate the smart contract.

5. The system of claim 1, the database system further configurable to cause
storing a smart contract identifier for the first smart contract in the metadata data structure; and
validating the first smart contract by performing a lookup of the smart contract identifier in a smart contract index.

6. The system of claim 1, the first file being an image file representing an image, the database system further configurable to cause:
applying a machine learning model to compare image features of the image with image features of a plurality of images stored in a database, the plurality of images being associated with corresponding smart contracts; and
transmitting a notification according to a result of applying the machine learning model.

7. The system of claim 1, the database system further configurable to cause:
operating a listener module that listens for events indicating that a non-fungible token has been minted;
obtaining an image file associated with the non-fungible token; and
providing the image to an image processing module that compares the image to images associated with a plurality of smart contracts.

8. A method, comprising:
identifying, from a metadata data structure associated with a non-fungible token, a first network address associated with a first attribute of the metadata data structure;
accessing a first file referenced by the first network address;
generating a first hash value from contents of the first file;
generating a modified metadata data structure that includes the first hash value by storing, within the metadata data structure, the first hash value in association with the first attribute;
generating a second hash value using the modified metadata data structure;
storing, in a public trust ledger, a first smart contract including the second hash value and a second network address that references the modified metadata data structure; and
attempting to validate a smart contract based, at least in part, on the second hash value.

9. The method of claim 8, wherein attempting to validate the smart contract comprises comparing the second hash value and a third hash value associated with the smart contract, the method further comprising:
transmitting a notification according to a result of attempting to validate the smart contract.

10. The method of claim 8, wherein attempting to validate the smart contract comprises:
for the smart contract, identifying a network address associated with the first attribute of an associated second metadata data structure;
generating a file hash value using contents of a file referenced by the network address;
modifying the second metadata data structure by storing the file hash value in association with the first attribute within the second metadata data structure;
generating a second temporary hash value using the modified second metadata data structure; and
determining whether the second temporary hash value is equal to the second hash value.

11. The method of claim 8, further comprising:
calling an application programming interface (API) via which the system attempts to validate the smart contract.

12. The method of claim 8, further comprising:
storing a smart contract identifier for the first smart contract in the metadata data structure such that the smart contract identifier is in the modified metadata data structure; and
validating the first smart contract by performing a lookup of the smart contract identifier in a smart contract index.

13. The method of claim 8, the first file being an image file representing an image, the database system further configurable to cause:
applying a machine learning model to compare image features of the image with image features of a plurality of images stored in a database, the plurality of images being associated with corresponding smart contracts; and
transmitting a notification according to a result of applying the machine learning model.

14. The method of claim 8, further comprising:
operating a listener module that listens for events indicating that a non-fungible token has been minted;
obtaining an image file associated with the non-fungible token; and
providing the image to an image processing module that compares the image to images associated with a plurality of smart contracts.

15. A non-transitory machine-readable storage medium having computer program instructions stored therein, the computer program instructions configured such that, when executed by one or more processors, the computer program instructions cause the one or more processors to:
identify, from a metadata data structure associated with a non-fungible token, a first network address associated with a first attribute of the metadata data structure;
access a first file referenced by the first network address;
generate a first hash value from contents of the first file;
generate a modified metadata data structure that includes the first hash value by store, within the metadata data structure, the first hash value in association with the first attribute;
generate a second hash value using the modified metadata data structure;
store, in a public trust ledger, a first smart contract including the second hash value and a second network address that references the modified metadata data structure; and
attempt to validate a smart contract based, at least in part, on the second hash value.

16. The non-transitory machine-readable storage medium of claim 15, the computer program instructions further configured such that, when executed by one or more processors, the computer program instructions cause the one or more processors to:
attempt to validate the smart contract comprises comparing the second hash value and a third hash value associated with the smart contract;
transmit a notification according to a result of attempting to validate the smart contract.

17. The non-transitory machine-readable storage medium of claim 15, the computer program instructions further configured such that, when executed by one or more processors, the computer program instructions cause the one or more processors to:
for the smart contract, identify a network address associated with the first attribute of the associated second metadata data structure;
generate a file hash value using contents of a file referenced by the network address;
modify the second metadata data structure by storing the file hash value in association with the first attribute within the second metadata data structure;
generate a second temporary hash value using the modified second metadata data structure; and
determine whether the second temporary hash value is equal to the second hash value.

18. The non-transitory machine-readable storage medium of claim 15, the computer program instructions further configured such that, when executed by one or more processors, the computer program instructions cause the one or more processors to:
attempt to validate the smart contract by comparing the second hash value with a third hash value associated with the smart contract; and
transmit a notification according to a result of attempting to validate the smart contract.

19. The non-transitory machine-readable storage medium of claim 15, the first file being an image file representing an image, the computer program instructions further configured such that, when executed by one or more processors, the computer program instructions cause the one or more processors to:
apply a machine learning model to compare image features of the image with image features of a plurality of images stored in a database, the plurality of images being associated with corresponding smart contracts; and
transmit a notification according to a result of applying the machine learning model.

20. The non-transitory machine-readable storage medium of claim 15, the computer program instructions further configured such that, when executed by one or more processors, the computer program instructions cause the one or more processors to:
operate a listener module that listens for events indicating that a non-fungible token has been minted;
obtain an image file associated with the non-fungible token; and
provide the image to an image processing module that compares the image to images associated with a plurality of smart contracts.
